(19) United States
(12) Patent Application Publication
(10) Pub. No.: US 2009/0208131 A1
(43) Pub. Date: Aug. 20, 2009

(54) Method and Device for Watermarking on Stream

(75) Inventors: Philippe Nguyen, Rennes (FR); Séverine Baudry, Rennes (FR); Corinne Naturel, Rennes (FR)

Correspondence Address: Thomson Licensing LLC, P.O. Box 5312, Two Independence Way, PRINCETON, NJ, 08543-5312, US

(73) Assignee: Thomson Licensing LLC

(21) Appl. No.: 12/086,373

(22) PCT Filed: Dec. 7, 2006
(86) PCT No.: PCT/EP2006/069433

§ 371 Date: Feb. 4, 2009

(30) Foreign Application Priority Data
Dec. 12, 2005 (FR) 0553828

(51) Int. Cl. G06K 9/36

(52) U.S. Cl. 382/276

(57) ABSTRACT

The invention relates in particular to a stream-wise method of watermarking independent of the compression parameters used (for example type of the transform) so as to allow the reading of the watermarking inserted independently of the format of the data received. The watermarking method according to the invention consists in generating a contribution matrix in the transformation space, in projecting it into another domain and in watermarking the data in this domain on the basis of the projected matrix so as to allow a watermark reader operating in the transformed transformation space to read back the inserted watermarking in the transformation space. The contribution matrix representing the modifications induced on the coefficients in the transformation space by insertion of the watermarking cue in this same domain.

### 1. FIELD OF THE INVENTION

The invention relates to a device and a method for watermarking or more precisely for inserting a fingerprint into a stream of compressed digital data.

### 2. STATE OF THE ART

The invention relates to the general field of the watermarking of digital data. More precisely, it relates to a particular application of watermarking which is the insertion of fingerprint into digital data. Subsequently in the document, the terms “fingerprint” and “watermark” are used interchangeably to designate the digital code inserted into the compressed digital data. In order to protect a digital content (for example a video, audio or 3D data, etc.), it is known to insert a unique fingerprint into each of the data streams distributed so as to identify the person or the body having authorized the transmission of the said content without authorization. Thus, during the promotion of a film, DVDs watermarked with the aid of a different fingerprint are dispatched to selected persons. In the case of a leak, it is possible by reconstructing the fingerprint to identify the source of the leak. Other applications are possible: insert a watermark making it possible to identify the work or the beneficiaries, or else to transmit auxiliary data (metadata) via the watermark. Generally, for reasons of an economic nature, but also calculation capacity and time constraints, the watermarking is performed stream-wise (i.e. watermarking of the compressed data before entropy coding). The thus watermarked video will undergo multiple transformations such as for example a transcoding. But most of the current watermarking techniques make the inserted watermark depend on the compression parameters (for example type of transformation used), and do not therefore allow the subsequent decoding of the watermarking information when the video content has undergone transformations.

### 3. SUMMARY OF THE INVENTION

The invention is aimed at alleviating at least one of the drawbacks of the prior art. More particularly, the invention proposes a stream-wise method of watermarking independent of the compression parameters used (for example type of the transform) so as to allow the reading of the watermark inserted independently of the format of the data received.

The invention relates in particular to a method of watermarking a data set which comprises:
a first step of transforming at least one group of data of the set by a first transform T₁ into a first group of coefficients in a first transformation space;
a first step of watermarking for watermarking the first group of coefficients according to a predetermined watermarking process;
a step for generating a first group of watermarking data representing the modifications induced by the first step of watermarking on the coefficients of the first group of coefficients;
a first step of projection of the first group of watermarking data into a second transformation space, this step generating a second group of watermarking data;
a second step of transformation of the group of data by a second transform into a second group of coefficients in the second transformation space; and
a second step of watermarking for watermarking the second group of coefficients with the second group of watermarking data.

Preferably, the step of projection consists in applying to the first group of watermarking data a transform inverse to the first transform T₁ then in applying the second transform T₂ to the first group of watermarking data after the transformation by the inverse transform.

Preferably, the first group of watermarking data is generated by calculating, for each of the coefficients of the first group of coefficients, the difference between the coefficient after the first step of watermarking and the coefficient before the first step of watermarking. The coefficients modified by the first step of watermarking being known, the difference is calculated only for these coefficients, the other differences being set to zero.

According to a preferred embodiment, the second step of watermarking of the second group of coefficients consists in adding to each of the coefficients of the second group of coefficients the corresponding datum of the second group of watermarking data.

According to a particular embodiment, the data set comprises coded data of a sequence of images, the group of data of the set comprises coded data of a block of pixels of one of the images of the sequence and the steps of the method are applied after decoding to the group of data of the set.

Preferably, the data set comprises data coded in accordance with one of the coding standards belonging to the set of standards comprising:
H.264;
MPEG-2; and
VC1.

Advantageously, the steps of the method are applied only to groups of data comprising coded data of pixel blocks belonging to images of the sequence that are coded independently of the other images of the sequence.

According to a particular characteristic, the first transform T₁ is a discrete cosine transform operating on pixel blocks of size 8 by 8 pixels.

According to another characteristic, the second transform T₂ is an integer transform approximating a discrete cosine transform operating on pixel blocks of size 4 by 4 pixels.

According to an advantageous embodiment, the step of projection is followed by a step consisting in zeroing a maximum number of watermarking data of the second group of watermarking data while maximizing the associated watermarking energy, this step generating a sparse group of watermarking data. The energy of the watermarking associated with the second group of watermarking data is proportional to the square root of the sum of the data of the second group of watermarking data squared.

Preferably, if the predetermined watermarking process modifies the value of a single coefficient in the first group of coefficients, the step consisting in zeroing a maximum number of watermarking data in the second group of watermarking data is followed by a step consisting in modifying the value of the nonzero data of the sparse group of watermarking data to generate a pre-emphasized sparse group of watermarking data in such a way that, when the pre-emphasized sparse group of watermarking data is projected into the first transformation space, the nonzero datum in the first group of watermarking data has the same value as the corresponding datum of the pre-emphasized sparse group of watermarking data after projection into the first transformation space.

According to an advantageous characteristic, the predetermined watermarking process consists for a first group of coefficients with which is associated a watermarking bit bi in modifying the value of at most two coefficients ┌₁ and ┌₂ of the first group of coefficients so that the following order relation holds:

|Γ₁′|=|Γ₂′|+d*Bᵢ,

where:
Γ₁′ and Γ₂′ are the two modified coefficients;
d is a marking parameter called the marking distance; and
Bᵢ is a coefficient whose value is defined as follows: Bᵢ=1 if bi=0 and Bᵢ=−1 if bi=1.

According to another advantageous embodiment, if the predetermined watermarking process modifies the value of N coefficients in the first group of coefficients, the step of projection into the second transformation space is performed jointly with a step consisting in zeroing data of the second group of watermarking data and a step consisting in modifying the values of the M data of the second group of nonzeroed watermarking data thus generating a pre-emphasized sparse group of watermarking data. The values and the positions of the M nonzero data are determined so that the quadratic energy associated with the pre-emphasized sparse group of watermarking data is minimized and so that when the pre-emphasized sparse group of watermarking data is projected into the first transformation space, each of the N nonzero data in the first group of watermarking data has the same value as the corresponding datum of the pre-emphasized sparse group of watermarking data after projection into the first transformation space, with N≧2 and M≧2. Preferably, N=M=2 and the quadratic energy associated with the pre-emphasized sparse group of watermarking data is equal the square root of the sum of the coefficients of the pre-emphasized sparse group of watermarking data squared.

Advantageously, the data set belongs to the group comprising:

data of the image sequence type;

data of the audio type; and

data of the 3D type.

The invention also relates to a device for watermarking a data set which comprises:
first means of transforming at least one group of data of the set into a first group of coefficients in a first transformation space;
first predetermined watermarking means for watermarking the first group of coefficients;
means for generating a first group of watermarking data representing the modifications induced by the first watermarking means on the coefficients of the first group of coefficients;
means for projecting the first group of watermarking data into a second transformation space, the means generating a second group of watermarking data;
second means of transforming the group of data into a second group of coefficients in the second transformation space; and
first watermarking means for watermarking the second group of coefficients with the second group of watermarking data.

The invention also relates to a computer program product that comprises program code instructions for the execution of the steps of the method according to the invention, when the said program is executed on a computer.

### 4. LISTS OF FIGURES

The invention will be better understood and illustrated by means of wholly nonlimiting advantageous exemplary embodiments and modes of implementation, with reference to the appended figures in which:

FIG. 1 illustrates the watermarking method according to the invention;

FIG. 2 represents various contribution matrices in the DCT and H transformation spaces;

FIG. 3 illustrates a particular embodiment of the watermarking method according to the invention;

FIG. 4 represents a sparse contribution matrix in the H space, pre-emphasized according to a particular embodiment of the invention;

FIG. 5 illustrates a watermark reading process operating in the DCT transformation space; and

FIG. 6 illustrates a watermarking device according to the invention.

### 5. DETAILED DESCRIPTION OF THE INVENTION

The invention relates to a method of watermarking a sequence of images or video independent of the compression parameters used to compress the said images. Each image of the sequence comprises pixels with each of which is associated at least one luminance value. When two pixel blocks are added together, this signifies that the value associated with a pixel with coordinates (i,j) in a block is added to the value associated with the pixel with coordinates (i,j) in the other block. When two pixel blocks are subtracted this signifies that the value associated with a pixel with coordinates (i,j) in a block is subtracted from the value associated with the pixel with coordinates (i,j) in the other block. Likewise, to a block of pixels can be added or from it subtracted a matrix M of coefficients of like size, the value associated with a pixel with coordinates (i,j) in the block being added to respectively subtracted from the value of the coefficient in position (i,j) denoted M(i,j) in the matrix. Generally, a matrix can be identified with a block of coefficients. The invention is more particularly described for a video stream coded in accordance with the MPEG-4 AVC video coding standard such as described in the document ISO/IEC 14496-10 (entitled “Information technology—Coding of audio-visual objects—Part 10: Advanced Video Coding”). In accordance with the conventional video compression standards, such as MPEG-2, MPEG-4, and H.264, the images of a sequence of images can be of intra type (I image), i.e. coded without reference to the other images of the sequence or of inter type (i.e. P and B images), i.e. coded by being predicted on the basis of other images of the sequence. The images are generally divided into macroblocks themselves divided into disjoint pixel blocks of size N pixels by P pixels, called N×P blocks. These macroblocks are themselves coded according to an intra or inter coding mode. More precisely all the macroblocks in an I image are coded according to the intra mode while the macroblocks in a P image can be coded according to an inter or intra mode. The possibly predicted macroblocks are thereafter transformed block by block using a transform, for example a discrete cosine transform referenced DCT or else a Hadamard transform. The thus transformed blocks are quantized then coded generally using variable-length codes. In the particular case of the MPEG-2 standard the macroblocks of size 16 by 16 pixels are divided into 8×8 blocks themselves transformed with an 8×8 DCT into transformed 8×8 blocks. In the case of H.264, the macroblocks of intra type relating to the luminance component can be coded according to the intra4×4 mode or according to the intra 16×16 mode. An intra macroblock coded according to the intra4×4 mode is divided into 16 disjoint 4×4 blocks. Each 4×4 block is predicted spatially with respect to certain neighbouring blocks situated in a causal neighbourhood, i.e. with each 4×4 block is associated a 4×4 prediction block generated on the basis of the said neighbouring blocks. 4×4 blocks of residuals are generated by subtracting the associated 4×4 prediction block from each of the 4×4 blocks. The 16 residual blocks thus generated are transformed by a 4×4 integer H transform which approximates a 4×4 DCT. An intra macroblock coded according to the intra 16×16 mode is predicted spatially with respect to certain neighbouring macroblocks situated in a causal neighbourhood, i.e. a 16×16 prediction block is generated on the basis of the said neighbouring macroblocks. A macroblock of residuals is generated by subtracting the associated prediction macroblock from the intra macroblock. This macroblock of residuals is divided into 16 disjoint 4×4 blocks which are transformed by the H transform. The 16 low-frequency coefficients (called DC coefficients) thus obtained are in their turn transformed by a 4×4 Hadamard transform. Subsequently in the document, the transform H which is applied to a macroblock designates a 4×4H transform applied to each of the 4×4 blocks of the macroblock if the macroblock is coded in intra4×4 mode and a 4×4H transform applied to each of the 4×4 blocks of the macroblock followed by a Hadamard transform applied to the DC coefficients if the macroblock is coded in intra 16×16 mode.

Watermark reading processes operating in the DCT transformation space on 8×8 blocks exist. These reading processes making it possible in particular to read watermarks inserted in the DCT transformation space by various processes.

A first watermarking process applied for example in the DCT transformation space to the 8×8 transformed blocks denoted B_{8×8}^{DCT} of an image to be watermarked consists in modifying possibly for each block B_{8×8}^{DCT} the order relation existing between the absolute values of two of its DCT coefficients, denoted Γ₁ and Γ₂. In general, these two coefficients are selected for a given block with the aid of a secret key. The bit bi of the fingerprint associated with a block B_{8×8}^{DCT} is inserted into this block by modifying the order relation existing between the absolute values of the two coefficients Γ₁ and Γ₂. In order to check the visibility of the watermark, the coefficients of a block are modified only if the following relation holds:

∥Γ₁|−|Γ₂∥<S

where S being a parametrizable threshold
The coefficients Γ₁ and Γ₂ are modified so that the following order relation holds:

|Γ₁′|=|Γ₂′|+d*Bᵢ (1)

where:
Γ₁′ and Γ₂′ are the modified coefficients,
d is a marking parameter called the marking distance, and
Bᵢ is a coefficient whose value is defined as follows: Bᵢ=1 if bi=0 and Bᵢ=−1 if bi=1.
   If the order relation already holds, neither of the two coefficients is modified. Γ₁ and Γ₂ can be modified in diverse ways so as to ensure the relation defined previously. Let us define e₁=Γ₁′−Γ₁ and e₂=Γ₂′−Γ₂, the values of e₁ and e₂ are defined for each block B_{8×8}^{DCT} in the following manner:

e₁=−Γ₁+sign(Γ₁)*(ƒ₁(Γ₁,Γ₂)+d₁) and e₂=−Γ₂+sign(Γ₂)*(ƒ₂(Γ₁,Γ₂)+d₂)

The choice of the function ƒ₁ is free, it is possible for example to choose ƒ₁(Γ₁,Γ₂)=ƒ₂(Γ₁,Γ₂)=|Γ₂|. For example, in the case where bi=0, let us choose d₂=−|Γ₂| and d₁=−|Γ₂|+d, then the order relation (1) does indeed hold. In the case where bi=1, let us choose d₁=−|Γ₂| and d₂=−|Γ₂|−d, then the order relation (1) also holds. The values of d and of S vary as a function of the application and in particular as a function of the risk of piracy. Specifically, the higher the value of d, the more robust the watermarking but the more visible it is. Thus to preserve a good visual quality of the sequence of images, the marking force must be limited.

According to a second watermarking process applied for example in the DCT transformation space a single coefficient Γ₁ per block B_{8×8}^{DCT} is modified so that |Γ₁′|=λ if bᵢ=0, |Γ₁′|=μ if bᵢ=1. The value λ or μ represents the value of the coefficient Γ₁ that the watermark reader must actually read to be able to identify the watermarking bit bᵢ. Such watermarking processes and therefore the processes for reading the watermark have already been developed to operate in the DCT transformation space on 8×8 transformed blocks.

The invention proposes a stream-wise method of watermarking based on a predetermined watermarking process such as for example one of the two watermarking processes described previously without it being limited to these two processes. The watermarking method according to the invention is independent of the compression parameters used. It is in particular independent of the type of the transform. It therefore make it possible to read in a certain transform domain (for example DCT) the watermark inserted in another transform domain (for example H) independently of the format of the data received. According to a particular embodiment, the invention makes it possible to watermark a sequence of images coded in accordance with the MPEG-4 AVC standard. The watermark inserted according to the invention can be read back by a watermark reader operating in the DCT transformation space on 8×8 blocks.

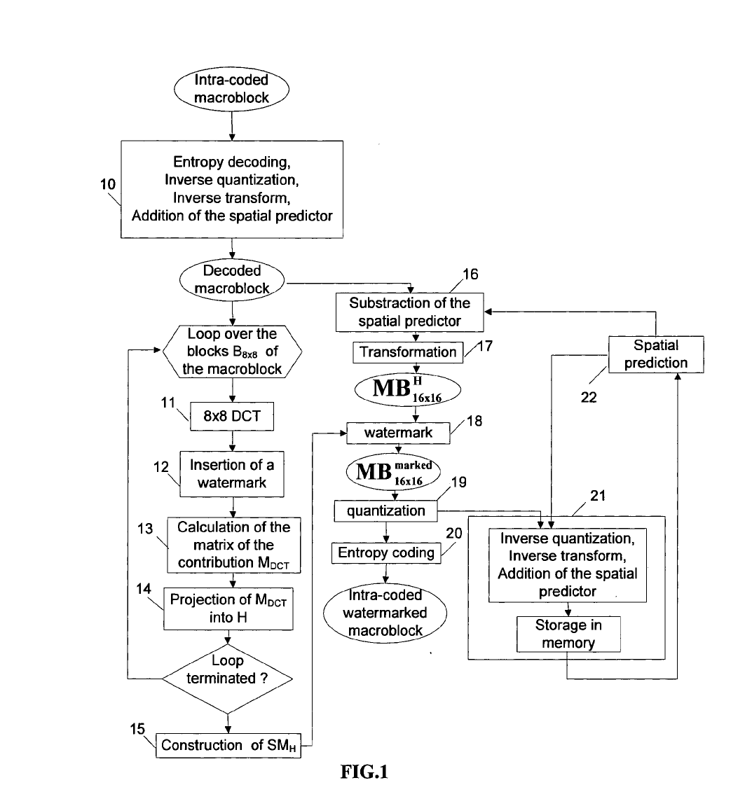

A first embodiment of the invention is illustrated by FIG. 1. Only the intra images, termed I images, of a sequence of images are watermarked, more particularly the luminance component of these images. The method according to the invention is described for a 16×16 macroblock referenced M_{16×16} and is preferably applied to all the 16×16 macroblocks of the I image.

Step 10 consists in decoding (e.g. entropy decoding, inverse quantization, inverse transform, and addition of the spatial predictor in the case of the H.264 standard) the parts of the stream of coded data corresponding to the macroblock MB_{16×16} so as to reconstruct the said macroblock. The rest of the method is described for an 8×8 block, referenced B_{8×8}, of the macroblock MB_{16×16} reconstructed and is applied to all the 8×8 blocks of this macroblock.

Step 11 consists in transforming the block B_{8×8} by an 8×8 DCT transform into an 8×8 transformed block denoted B_{8×8}^{DCT}.

Step 12 consists in watermarking the block B_{8×8}^{DCT} according to a predetermined watermarking process such as for example the first or the second watermarking process described previously or else any other watermarking process making it possible to watermark the image in the DCT transformation space. The watermarking bit assigned to the block B_{8×8}^{DCT} is determined by the fingerprint to be inserted into the I image to which the block B_{8×8}^{DCT} belongs. This step makes it possible to generate a watermarked block denoted B_{8×8}^{DCT}^{_{Marked}}.

In step 13, the block B_{8×8}^{DCT} is subtracted from the block B_{8×8}^{DCT}^{_{marked}} so as to generate a first group of data or watermarking coefficients called a contribution matrix and denoted M_{DCT}. According to another embodiment, this difference is calculated only on the coefficients of the block relevant to the watermarking, i.e. the coefficients of the block modified by the watermarking.

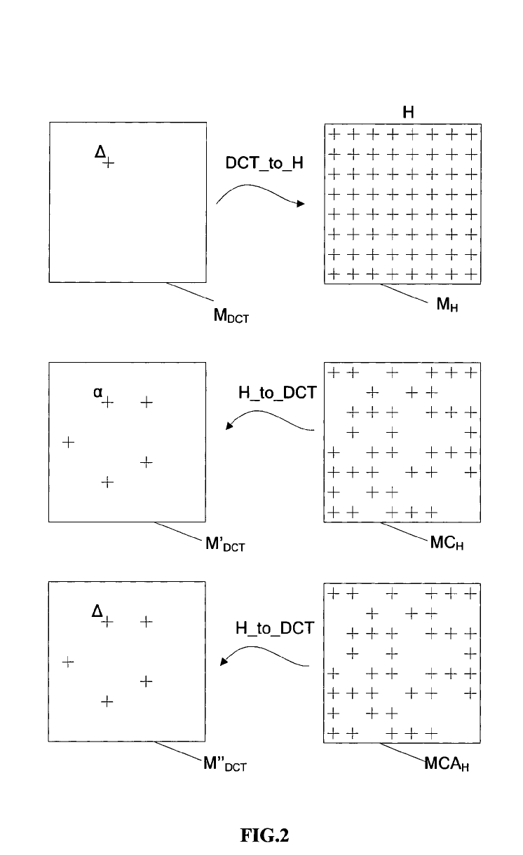

Step 14 consists in expressing the matrix M_{DCT} in the basis H. i.e. in projecting the matrix M_{DCT} into the H space to generate a second group of data or watermarking coefficients also called a contribution matrix and denoted M_{H}. For this purpose, an inverse DCT transform is applied to the matrix M_{DCT} to generate a matrix M_{DCT}⁻¹. The H transform is thereafter applied to each of the 4×4 blocks of the matrix M_{DCT}⁻¹ to generate, in the H space, the contribution matrix M_{H}. The change of basis has the effect of distributing over several coefficients the modification induced by the watermarking which was concentrated on one or two coefficients in the DCT basis. FIG. 2 illustrates the case where the predetermined watermarking process modifies a single coefficient in the DCT space, the others being zero while in the matrix M_{H} numerous coefficients are nonzero. In this figure the nonzero coefficients are represented by a cross.

When the four contribution matrices M_{H} associated with each of the 8×8 blocks of the macroblock MB_{16×16} are generated then the four contribution matrices M_{H} are grouped together in step 15 to form a contribution super-matrix SM_{H} of size 16×16 so that each of the matrices M_{H} has the same position in the super-matrix SM_{H} as the 8×8 block with which it is associated in the macroblock MB_{16×16}. If the macroblock MB_{16×16} is coded according to the intra 16×16 mode then a 4×4 Hadamard transform is applied to the 16 DC coefficients of the super-matrix SM_{H}. If none of the macroblocks MB_{16×16} is coded according to the intra 16×16 mode then this step can be omitted.

In step 16, the spatial predictor generated in step 22 is subtracted from the macroblock MB_{16×16} so as to generate a macroblock of residuals which is transformed in step 17 by the H transform and possibly by the 4×4 Hadamard transform in accordance with MPEG-4 AVC. The macroblock thus generated is denoted MB_{16×16}^{H}.

Step 18 of watermarking in the H transformation space, also called the writing space, consists then in adding the contribution super-matrix SM_{H} to the macroblock MB_{16×16}^{H} to generate a watermarked macroblock denoted MB_{16×16}^{Marked}. The macroblock MB_{16×16}^{Marked} watermarked in the transformed space of MPEG-4 AVC is then quantized in step 19 then coded by entropy coding in step 20.

When all the data relating to the I images to be watermarked have been processed, they are multiplexed with the other data of the initial stream of undecoded digital data comprising in particular the data relating to the other images of the sequence.

To the macroblock MB_{16×16}^{Marked} quantized in step 19 is applied in step 21 an inverse quantization and an inverse transform (which corresponding to the inverse H transform and possibly which takes account of the 4×4 Hadamard transform). To the macroblock thus generated is added the spatial prediction macroblock which has served in step 16 for the spatial prediction of the macroblock MB_{16×16}. The macroblock thus generated is stored in memory to serve for the spatial prediction of future macroblocks.

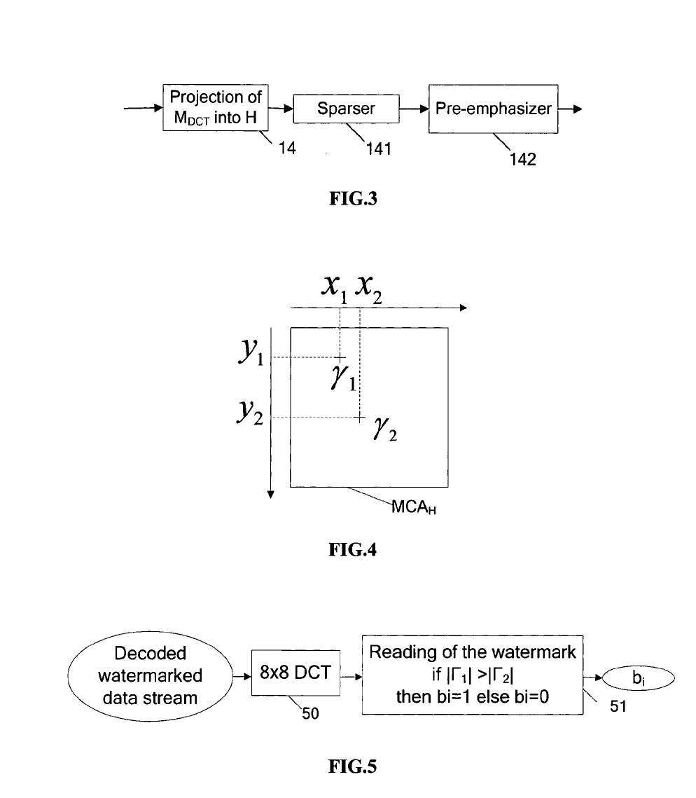

According to another embodiment illustrated by FIG. 3, the matrix M_{H} is thinned out during a step 141, i.e. some of its coefficients are zeroed, prior to the watermarking performed in step 18 so as to limit the increase in the bit rate related to the insertion of the watermarking while limiting the modification due to the watermarking. The sparse matrix thus generated is denoted MC_{H} in FIG. 2. This figure illustrates the particular case where the predetermined watermarking process modifies only a single DCT coefficient per 8×8 block. The sparser the matrix M_{H}, the more deformed will be the resulting watermark in the DCT transformation space and the more its energy will be decreased. In order to minimize these effects, the sparse matrix MC_{H} selected is the matrix which maximizes the product of the energy E_{MC}of the sparse matrix times the sparseness TC of the matrix MC_{H}. The energy E_{MC} which is proportional to the watermarking energy in the DCT transformation space is defined as follows:

$${E}_{MC} = \sqrt{{\sum }_{i , j}^{ } {{MC}_{H} ( i , j )}^{2}} \qquad ( 2 )$$

TC is equal to the ratio of the number of zero coefficients of the matrix to the total number of coefficients of the matrix MC_{H}. The sparse matrix MC_{H} is selected for example by searching in an exhaustive manner among the set denoted {MC}_{M}_{_{H}} of the sparse matrices created from M_{H} for that one which maximizes the product E_{MC} times TC. For this purpose, the product E_{MC}*TC is calculated for each of the matrices of the set {MC}_{M}_{_{H}} and is stored in memory. The matrix of the set {MC}_{M}_{_{H}} which maximizes the product E_{MC}*TC is selected.
According to a variant, a minimum value of watermarking energy is fixed. This value corresponds to a minimum value of energy of the sparse matrix equal to E_{MC}^{min}. The sparse matrix MC_{H} selected is the solution of a constrained optimization problem which consists in determining in the set {MC}_{M}_{_{H}} the sparse matrix having the largest number of zero coefficients and whose energy is greater than or equal to E_{MC}^{min}. The constrained optimization can be performed by a Lagrangian procedure. According to a variant, the energy of the sparse matrix used to characterize the energy of the watermarking can be defined differently, for example by weighting the preceding expression (2) as a function of the spatial frequency of the coefficients. For this purpose, the higher the frequency of a coefficient the lower the weight assigned to this coefficient.

According to a particular embodiment, the matrix MC_{H} is pre-emphasized or precompensated prior to the watermarking performed in step 18 so as to take account of the bias introduced into the DCT transformation space by the step consisting in thinning out the matrix M_{H} which disturbs the reading of the watermark in the DCT space. The pre-emphasized sparse matrix is denoted MCA_{H}. The step of pre-emphasis 142 consists in modifying the nonzero coefficients of the sparse matrix MC_{H} to generate the matrix MCA_{H} in such a way that this matrix is the closest possible in the reading space (i.e. space in which the reading of the modification induced by the watermarking is performed, in this instance the DCT space) to the desired reading result, for example so as to minimize the mean square error |MCA_{H}−M_{H}|². This embodiment illustrated by FIG. 2 makes it possible for example to pre-emphasize the matrix MC_{H} when the predetermined watermarking process used to watermark the 8×8 transformed blocks modifies only a single coefficient Γ₁ as does the second watermarking process described at the start of the document. Let us assume that the modified coefficient Γ₁ is positioned at (i₀, j₀) in the block B_{8×8}^{DCT} and that |Γ₁′|=λ. In the matrix M′_{DCT} obtained by projecting MC_{H} into the DCT transformation space the coefficient at position (i₀, j₀) has the value α instead of the value Δ=λ−|Γ₁| which alone allows a correct reading of the watermarking bit bᵢ. The matrix MC_{H} is therefore pre-emphasized to generate a pre-emphasized sparse matrix, denoted MCA_{H}, so that the value of the coefficient at position (i₀, j₀) in the matrix M″_{DCT}, the projection of MCA_{H} into the DCT transformation space, is equal to Δ. In the embodiment according to the invention, the matrix MCA_{H} is defined in the following manner:

MCA_{H}(i,j)=0 for all the zero coefficients of the matrix MC_{H} and

$${MCA}_{H} ( i , j ) = \frac{1}{β} {MC}_{H} ( i , j )$$

for the other coefficients of the matrix MC_{H}, where

$$β = \frac{α}{λ - \vert {Γ}_{1} \vert} ,$$

with α≠0 and where α is the coefficient at position (i₀, j₀) in the DCT space of the sparse matrix MC_{H}. This pre-emphasis makes it possible to guarantee that the coefficient at position (i₀, j₀) modified by the watermarking in the contribution matrix M″_{DCT} does indeed have the value λ−|Γ₁| and therefore that the value of the coefficient Γ₁ modified by the watermarking does indeed have the value λ.

According to a preferred embodiment, the matrix M_{H} is thinned out and pre-emphasized jointly. If the predetermined watermarking process modifies two coefficients Γ₁ and Γ₂ as does the first watermarking process described at the start of the document, then in the contribution matrix M_{DCT} associated with a block B_{8×8} only two coefficients e₁ and e₂ are nonzero. The matrix MCA_{H} is then determined directly from M_{DCT}. MCA_{H} which is a matrix only two of whose coefficients are nonzero is defined by the following relation: MCA_{H}=γ₁M(X₁)+γ₂M(X₂), where M(Xᵢ) is a matrix all of whose coefficients are zero except the coefficient at position Xᵢ(xᵢ, yᵢ) whose value is equal to 1. Such a matrix MCA_{H} is represented in FIG. 4. The projection of the matrix MCA_{H} into the DCT transformation space is denoted M_{DCT}^{p}. The coefficients of M_{DCT}^{p} localized e′₂=g(γ₁, γ₂, X₁, X₂). The values γ₁ and γ₂ are solutions of the following system: f(γ₁, γ₂,X₁,X₂)=e₁ and g(γ₁, γ₂,X₁,X₂)=e₂. The values γ₁ and γ₂ thus determined depend on the values of X₁ and X₂. These last two values are determined by an exhaustive traversal of all the possible position pairs in the matrix MCA_{H}. For each of the pairs (X₁, X₂), the resulting values γ₁ and γ₂ are calculated together with the corresponding quadratic energy E(γ₁, γ₂). The values of X₁ and X₂ selected are those which minimize E(γ₁, γ₂) so as to decrease the visual impact of the watermark. This embodiment described for two coefficients can be applied to N coefficients, |N|_{[AL1]}≧1.

According to another embodiment, the quantization parameter defined for quantizing each 4×4 block of the I image is modified. A maximum threshold of deformation of the watermarking signal is permitted. The measure of deformation is the mean square error (MSE) between the quantized watermarked signal and the watermarked signal calculated as follows:

$$MSE = \sqrt{{\sum }_{i , j}^{ } {( {S}_{H}^{′} ( i , j ) - {S}_{H}^{{Q}^{′}} ( i , j ) )}^{2}} ,$$

where:
S_{H}(i,j) is the value associated with the pixel with coordinates (i,j) of the initial signal after spatial prediction and transformation,
S′_{H}(i,j) is the value associated with the pixel with coordinates (i,j) of the watermarked signal S_{H}(i,j), and
S_{H}(i,j) is the value associated with the pixel with coordinates (i,j) of the signal S′_{H}(i,j) after quantization.
   The maximum watermarking threshold S_{T} is defined as a function of the chosen deformation measure. According to a particular characteristic,

$${S}_{T} = \sqrt{{\sum }_{i , j}^{ } {( {S}_{H} ( i , j ) - {S}_{H}^{{ }^{′}} ( i , j ) )}^{2}} .$$

The quantization parameter for a given 4×4 block is decreased until the induced deformation is lower than the threshold S_{T}.

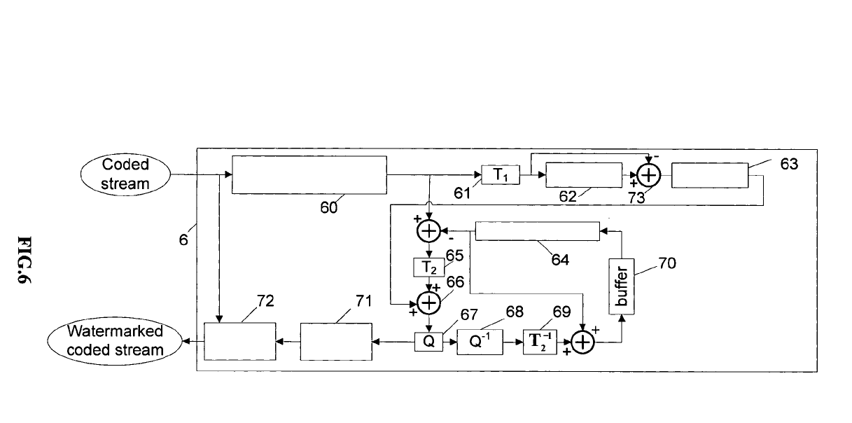

FIG. 5 represents a conventional watermark reading process operating in the DCT transformation space making it possible to read the watermark of a stream of data watermarked in accordance with the invention in the H transformation space when the predetermined watermarking process used is the first process described which modifies two coefficients Γ₁ and Γ₂. The 8×8 blocks of a decoded image are transformed by 8×8 DCT in step 50. The watermark reading step 51 processes each of the macroblocks of the image and consists in reading back the associated watermarking bit bᵢ. Advantageously according to the invention such a reading process can be reused to read a watermark inserted by the watermarking method according to the invention even if this watermarking has been performed in a domain of representation other than the DCT domain.

The invention also relates to a watermarking device 6 such as illustrated by FIG. 6 which receives as input a stream of digital data coded for example in accordance with the MPEG-4 AVC syntax. This device is able to implement the method according to the invention. In this figure, the modules represented are functional units, which may or may not correspond to physically distinguishable units. For example, these modules or some of them can be grouped together into a single component, or constitute functionalities of one and the same software. Conversely, certain modules may possibly be composed of separate physical entities. According to a particular embodiment, the parts of the stream of data relating to the I images are thereafter decoded by a module 60 operating the reconstruction of the macroblocks (i.e. entropy decoding, inverse quantization, inverse transformation and possibly addition of the spatial prediction of the macroblocks in the case of a stream coded in accordance with the MPEG-4 AVC syntax). The pixel blocks thus reconstructed are thereafter transformed by a module 61. A watermarking module 62 makes it possible to watermark the pixel blocks transformed by a transform T₁, for example a DCT. The watermarking device furthermore comprises a module 73 making it possible to subtract from each of the thus watermarked blocks the corresponding unwatermarked block to generate a first watermarking cue also called a contribution matrix M_{DCT}. A module 63 makes it possible to project the matrices M_{DCT} into the H transformation space, or more generally into the transformation space T₂, so as to generate for each 8×8 block a second watermarking cue called a contribution matrix M_{H}. This module makes it possible also to generate the contribution super-matrix such as defined previously if necessary. The device furthermore comprises an optional spatial prediction module 64 and a module 65 operating an H transform or more generally a transform T₂. A module 66 makes it possible to watermark the data transformed by the module 65 in the second transformation space by adding to these transformed data the second watermarking cue generated by the module 63. A module 67 makes it possible to quantize the watermarked macroblock. The device also comprises a module 68 operating an inverse quantization and a module 69 operating an inverse transformation. It moreover comprises a memory 70 making it possible to store the watermarked and decoded macroblocks. Finally, the device comprises a module 71 for entropy coding and a multiplexer 72 making it possible to multiplex the data watermarked according to the invention with the other data of the coded initial stream. The modules 64, 68, 69 and 70 are optional. Specifically, not all the coding standards make it necessary to spatially predict the data before decoding them.

Of course, the invention is not limited to the exemplary embodiments mentioned above. In particular, the person skilled in the art can incorporate any variant into the embodiments set forth and combine them to benefit from their various advantages. In particular the invention described within the framework of a video coding based on the H.264 standard can be extended to any type of support data (audio, 3D data). The embodiments described for a DCT transform and an H transform can be extended to any type of transform. In a general manner, the watermarking method according to the invention consists in watermarking digital data in a first transformation space T1, in generating in this space T1 a first group of coefficients M_{T1} which corresponds to the contribution matrix M_{DCT} in the embodiment described previously, in projecting it into another transformation space T₂ to generate a second group of coefficients which corresponds to the contribution matrix M_{H} in the embodiment described previously and in watermarking the data in this transformation space T₂. A watermark reader operating in the transformation space T₁ can then read back the watermark inserted in the transformation space T₂. In particular, the invention can be applied to other video coding standards such as the VC1 standard described in the SMPTE document entitled “proposed SMPTE Standard for Television: VC1 Compressed Video Bitstream Format and Decoding Process>> and referenced SMPTE 421M. When the invention is used with coding standards not using spatial prediction, then steps 16, 21 and 22 of the method according to the invention are not applied. Likewise step 15 is not necessarily applied when the second transform T₂ operates solely on blocks of a single size, for example 8×8 blocks. The present invention is not limited to the watermarking processes described previously. Furthermore, the invention has been described in respect of the watermarking of the intra images but can also be applied to the predicted images.

1. Method of watermarking a data set comprising:
a first step of transforming at least one group of data of the said set by a first transform into a first group of coefficients in a first transformation space;
a first step of watermarking for watermarking the said first group of coefficients according to a predetermined watermarking process;
a step for generating a first group of watermarking data representing the modifications induced by the said first step of watermarking on the coefficients of the said first group of coefficients;
a first step of projection of the said first group of watermarking data into a second transformation space, the said step generating a second group of watermarking data;
a second step of transforming the said at least one group of data by a second transform into a second group of coefficients in the said second transformation space; and
a second step of watermarking for watermarking the said second group of coefficients with the said second group of watermarking data.

2. Method according to claim 1, wherein the first group of watermarking data is generated by calculating, for each of the said coefficients of the said first group of coefficients, the difference between the said coefficient after the first step of watermarking and the said coefficient before the first step of watermarking.

3. Method according to claim 2, wherein the coefficients modified by the said first step of watermarking being known, the said difference is calculated only for these coefficients, the other differences being set to zero.

4. Method according to claim 1, wherein the second step of watermarking of the said second group of coefficients consists in adding to each of the said coefficients of the said second group of coefficients the corresponding datum of the said second group of watermarking data.

5. Method according to claim 1, wherein the said data set comprises coded data of a sequence of images, in that the said at least one group of data comprises coded data of a block of pixels of one of the said images of the said sequence and in that the steps of the method are applied after decoding to the said at least one group of data.

6. Method according to claim 5, wherein the said data set comprises data coded in accordance with one of the coding standards belonging to the set of standards comprising:
H.264;
MPEG-2; and
VC1.

7. Method according to claim 5, wherein the steps of the method are applied only to groups of data comprising coded data of pixel blocks belonging to images of the said sequence that are coded independently of the other images of the said sequence.

8. Method according to claim 5, wherein the first transform is a discrete cosine transform operating on pixel blocks of size 8 by 8 pixels.

9. Method according to claim 5, wherein the second transform is an integer transform approximating a discrete cosine transform operating on pixel blocks of size 4 by 4 pixels.

10. Method according to claim 1, wherein the step of projection is followed by a step consisting in zeroing a maximum number of watermarking data of the said second group of watermarking data while maximizing the associated watermarking energy, the said step generating a sparse group of watermarking data.

11. Method according to claim 10, wherein the energy of the watermarking associated with the said second group of watermarking data is proportional to the square root of the sum of the data of the said second group of watermarking data squared.

12. Method according to claim 10, wherein, if the predetermined watermarking process modifies the value of a single coefficient in the said first group of coefficients, the step consisting in zeroing a maximum number of watermarking data in the said second group of watermarking data is followed by a step consisting in modifying the value of the nonzero data of the said sparse group of watermarking data to generate a pre-emphasized sparse group of watermarking data in such a way that, when the said pre-emphasized sparse group of watermarking data is projected into the said first transformation space, the nonzero datum in the said first group of watermarking data has the same value as the corresponding datum of the said pre-emphasized sparse group of watermarking data after projection into the said first transformation space.

13. Method according to claim 1, wherein the said predetermined watermarking process consists for a first group of coefficients with which is associated a watermarking bit bi in modifying the value of at most two coefficients Γ₁ and Γ₂ of the said first group of coefficients so that the following order relation holds:

|Γ₁′|=|Γ₂′|+d*Bᵢ,
where:
Γ₁′ and Γ₂′ are the two modified coefficients;
d is a marking parameter called the marking distance; and
Bᵢ is a coefficient whose value is defined as follows: Bᵢ=1 if bi=0 and Bᵢ=−1 if bi=1.

14. Method according to claim 1, wherein, if the predetermined watermarking process modifies the value of N coefficients in the said first group of coefficients, the step of projection into the said second transformation space is performed jointly with a step consisting in zeroing data of the said second group of watermarking data and a step consisting in modifying the values of the said M data of the said second group of nonzeroed watermarking data thus generating a pre-emphasized sparse group of watermarking data and in that the values and the positions of the said M nonzero data are determined so that the quadratic energy associated with the said pre-emphasized sparse group of watermarking data is minimized and so that when the said pre-emphasized sparse group of watermarking data is projected into the said first transformation space, each of the N nonzero data in the said first group of watermarking data has the same value as the corresponding datum of the said pre-emphasized sparse group of watermarking data after projection into the said first transformation space, with N≧1 and M≧1.

15. Method according to claim 14, wherein M=2 and N=2.

16. Method according to claim 14, wherein the quadratic energy associated with the said pre-emphasized sparse group of watermarking data is equal the square root of the sum of the coefficients of the said pre-emphasized sparse group of watermarking data squared.

17. Method according to claim 1, wherein the step of projection consists in applying to the said first group of watermarking data a transform inverse to the said first transform then in applying the said second transform to the said first group of watermarking data after the said transformation by the said inverse transform.

18. Method according to claim 1, wherein the said data set belongs to the group comprising:
data of the image sequence type;
data of the audio type; and
data of the 3D type.

19. Device for watermarking a data set comprising:
first means of transforming at least one group of data of the said set into a first group of coefficients in a first transformation space;
first predetermined watermarking means for watermarking the said first group of coefficients;
further comprising
means for generating a first group of watermarking data representing the modifications induced by the said first watermarking means on the coefficients of the said first group of coefficients;
means for projecting the said first group of watermarking data into a second transformation space, the said means generating a second group of watermarking data;
second means of transforming the said at least one group of data into a second group of coefficients in the said second transformation space; and
first watermarking means for watermarking the said second group of coefficients with the said second group of watermarking data.

20. Computer program product comprising program code instructions for the execution of the steps of the method according to claim 1, when the said program is executed on a computer.
